(19) United States
(12) Patent Application Publication
(10) Pub. No.: US 2009/0132613 A1
(43) Pub. Date: May 21, 2009

(54) Apparatus, Method and System For Restoring Files

(75) Inventor: Sandeep Lakshmipathy, Bangalore (IN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/912,309

(22) PCT Filed: Apr. 18, 2006
(86) PCT No.: PCT/IB2006/051193

§ 371 Date: Oct. 23, 2007

(30) Foreign Application Priority Data
Apr. 25, 2005 (EP) 05103337.1

(51) Int. Cl. G06F 12/16; G06F 12/00; G06F 12/02

(52) U.S. Cl. 707/204; 707/205; 711/E12.001; 711/E12.002

(57) ABSTRACT

The invention describes a method, system, recording medium for a program and the related program to restore information files. The invention specifically addresses the technical field of mobile storage devices used in co-operation with a, generally larger, repository of information. A user can identify files to be transferred from a computer (2, 3) to a mobile storage device (4, 5). The invention ensures that administrative information (12) is created locally to the user, optionally including time and date information (13), to enable future information file restoration. Only administrative information (12) is preserved. Multiple copies of information files are not made resulting in modest usage of backup storage space. The invention is particularly useful for generally available information files. Administrative information (12) may be stored locally (5, 6) or remotely and uniquely identifies the information files allowing restoration from any repository containing the information files to be restored.

### BACKGROUND OF THE INVENTION

1. Field of the Invention

The present invention relates to information processing and in particular to methods, systems, apparatuses and recording media and programs for use therein for restoring files.

2. Description of the Related Art

In recent years there has been a proliferation of storage devices used in many cases to make information more mobile, due to the increasing mobility of consumers. For example mobile storage devices based on flash memory and hard disk drive devices are common. Such devices are used for information in general and also in specific applications such a portable music and video jukeboxes. In any of these products it is desirable if consumers have the peace of mind of being able to restore the information on their mobile storage devices should a situation arise within which information has been lost, through accident or abuse. The traditional approach to giving peace of mind to the consumer is to make a complete backup of the information on the mobile storage device. Such complete backups may be stored on a personal computer, or on removable storage media such as floppy or hard disks, or optical storage media. A drawback with this solution is that the amount of backup storage space required quickly increases, especially in cases of mobile storage devices that often store a subset of the information held on a personal computer. Such cases often lead to the need to store multiple backups of identical files and therefore wasted backup storage capacity. This is especially unnecessary for information files that are commonly available from many sources. Exemplary examples of such files are audio files, such as MP3 or WMA files. Identical files can be found in many repositories, purchased and/or re-encoded from, for example, the original CD. Further exemplary information files could be shared library files available on a general-purpose computer. For such information files a strict restoration scheme is often unnecessary especially when applied to the mobile storage device. A solution to limit wasting of excessive backup storage space, and reduce the related cost, is proposed in United State Patent Application US 2005/0010616. This example of prior art provides a remote backup/restoration service and associated remote server to offer a consumer the required peace of mind and at the same time minimise the wastage of backup storage space. However, as with all remote service based solutions a consumer has no control over the service and is at the complete mercy of the service provider. It is well known that remote services can stop from one day to the next for technical or business reasons, such as a business model being commercially unviable, furthermore, some consumers prefer not to make use of remote service providers and wish to remain in control. Furthermore, the service providers usually charge a fee for providing backup and restore services.

Therefore, there remains a need to provide a manner for consumers to enjoy in essence the peace of mind of being able to restore the information on their mobile storage devices using the minimum amount of backup storage space whilst remaining in control and independent from a service or service provider.

### BRIEF SUMMARY OF THE INVENTION

It is an object of the present invention to provide a method, system and apparatus to enable a user to restore information making efficient use of available storage space in an independent manner.

In accordance with a first aspect of the present invention this object is realized by a method for restoring files, the method comprising: storing a plurality of files in a first memory area; selecting a selection of files comprising of at least one of said plurality of files; storing of said selection of files in a second memory area; identifying with a plurality of first identifiers each file of said selection of files; storing said first identifiers and conditions of storage in a list of information; receiving a request from a user for files to be restored to said second memory area; identifying with a plurality of second identifiers each file of said plurality of files stored in said first memory area; comparison of equality of each one of said first identifiers of said files to be restored with each one of said second identifiers; and restoring said files to be restored to said second memory area for which said comparison is true.

Advantageously the method as defined in claim 2 can be made use of to provide an essentially unique identifier of an information file in a form more compact than the information file itself. Furthermore, it is favourable if metadata that is contained within the information file or is related to the information file is used to generate a unique identifier. For cases when a system is used to store audio information files the metadata contained within the information file can advantageously be used. Such metadata is commonly known as the ID3 tag of MP3 or WMA information files.

It is further advantageous if the list of information may be stored in one of a selection of physical locations as described in the measure defined in claim 5. It is also advantageous if a user is able to perform restoration from a further repository that was previously unknown to the user as described in the measure of claim 6 for information files which are generally available. In situations when a user would like to restore files to a specific point in time then the measures described in claims 7 and 8 are favourable.

According to a second aspect of the present invention the object is realized by providing a system as claimed in claim 9. Further advantageous measures for the system are defined in claims 10 through 13.

A third aspect of the present invention realizes the object by providing an information processing apparatus for restoring files according to claim 14. A fourth aspect of the invention provides a computer-readable recording medium to realize the object of the invention as claimed in claim 15. According to a fifth aspect of the present invention the object is realized by providing, as defined in claim 16, a program for controlling an information processing apparatus for restoring files.

These and other aspects of the invention will be apparent from and elucidated with reference to the embodiments described hereinafter.

### BRIEF DESCRIPTION OF THE DRAWINGS

The invention will be described with reference to the accompanying drawings, in which:

FIG. 1 is a block diagram illustrating a first embodiment of the invention;

FIG. 2 is a block diagram illustrating a second embodiment of the invention;

FIG. 3 is a block diagram illustrating a third embodiment of the invention;

FIG. 4 is a block diagram illustrating a fourth embodiment of the invention for use during the information file restoration phase only;

FIG. 5 is a flowchart illustrating the method of adding information files for use in an embodiment of the invention taking account of the preparation necessary to restore information files at a later occasion;

FIG. 6 is a flowchart illustrating the method of removing information files for use in an embodiment of the invention; and

FIG. 7 is a flowchart illustrating the method of restoring information files, during an information file restoration phase, for use in an embodiment of the invention.

### DETAILED DESCRIPTION OF THE INVENTION

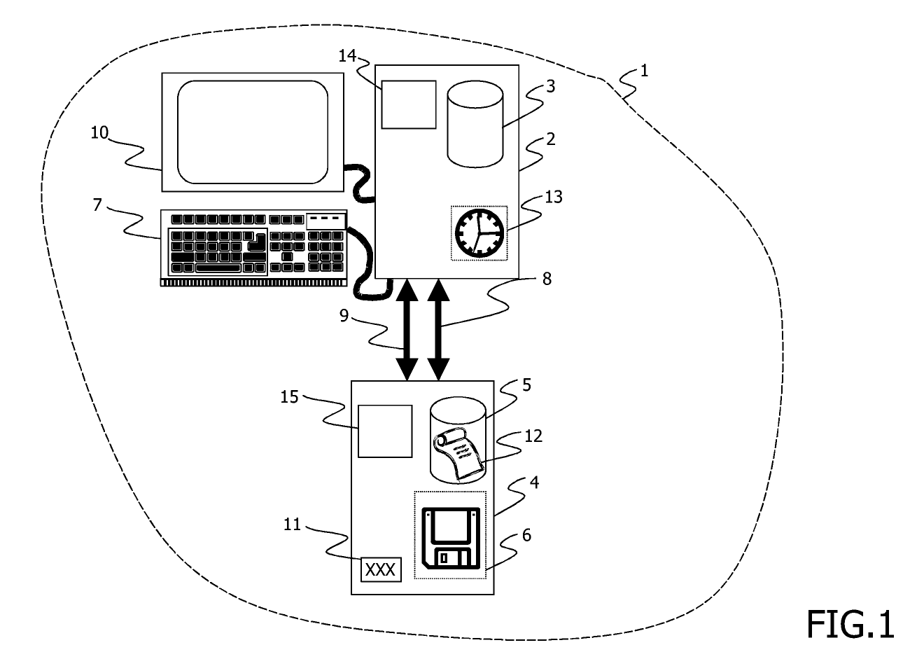

In FIG. 1 an embodiment is shown of the present invention. Illustrated is a system 1 for restoring files. A user interacts with a first local device 2 comprising a storage medium with a first memory area 3, a first processor 14 and an optional time and date mechanism 13. The interaction process makes use of the first processor 14, a display 10 and a user input device 7, for example a keyboard. Any other suitable user input device may also be used such as a mouse, trackball, joystick etc. The user generally stores information files in the first memory area 3. It is common for a user to wish to make information files available whilst mobile. This is commonly achieved using mobile storage devices. A second local device 4, which may be small and portable, can be attached to the first local device 2 such that information files may be exchanged using information file connection 9. An exemplary form of such a second local device is a mobile storage device, such as a USB connected hard disk drive. Further examples are non volatile memory drives, such as flash memory based or magnetic random access memory (MRAM) based, or IEEE1394 connected hard disk drives. A person skilled in the art would recognize suitable equivalents thereof. The second local device 4 comprises a second processor 15, a storage medium with a second memory area 5, a unique identification 11 and an optional third memory area 6. The unique identification 11 is capable of uniquely identifying second local device 4 to the first local device 2 or any other device to which it connects. An administrative connection 8 can be provided separate from the information file connection 9 to isolate administrative information required for the enabling and performing of restore operations. A list of information 12 is used to denote such administrative information required for the enabling and performing of restore operations. The list of information 12 can optionally comprise the unique identification 11 of the second local device 4. The first processor 14 constructs the list of information 12 by identifying each file transferred to the second memory area 5 from the first memory area 3 using a plurality of first identifiers. For cases when the information file has already been transferred to the second memory area 5 via the information file connection 9 then the second processor 15 can optionally perform the processing of the list of information 12. The optional time and date mechanism 13 of the first local device 2 can be used to register and log the time and date of each action performed and further stores the time and date as conditions of storage in the list of information 12. Such a measure enables information file restoration to a specific point in time. The separation of the list of information 12 and the information files themselves provides enhanced protection for information files of users from accidental destruction. In FIG. 1 the list of information 12 is shown to be stored in second memory area 5. Further protection can be arranged by storing the list of information 12 in the optional third memory area 6 instead of in the second memory area 5. This is not shown in FIG. 1. Ideally the optional third memory area 6 would not be accessible to a user in normal operation making accidental deletion of the list of information 12 less likely. The optional third memory area 6 may of course be a separate physical memory chip, a separate memory area of an existing memory array or any other suitable non-volatile memory device.

Should accidental deletion of information files occur, a user can request the restoration of files using the display 10 and the user input device 7. The first processor 14 then identifies each information file in first memory area 3 using a plurality of second identifiers. The first processor 14 then compares the plurality of first identifiers from the list of information 12 with the plurality of second identifiers. Information files for which one of the plurality of first identifiers matches one of the plurality of second identifiers are then restored from first memory area 3 to second memory area 5. In this embodiment the second local device 4 contains all necessary information to restore the information files. The first local device 2 may execute a suitable program, but does not comprise any unique administrative information with respect to the activity of restoring files.

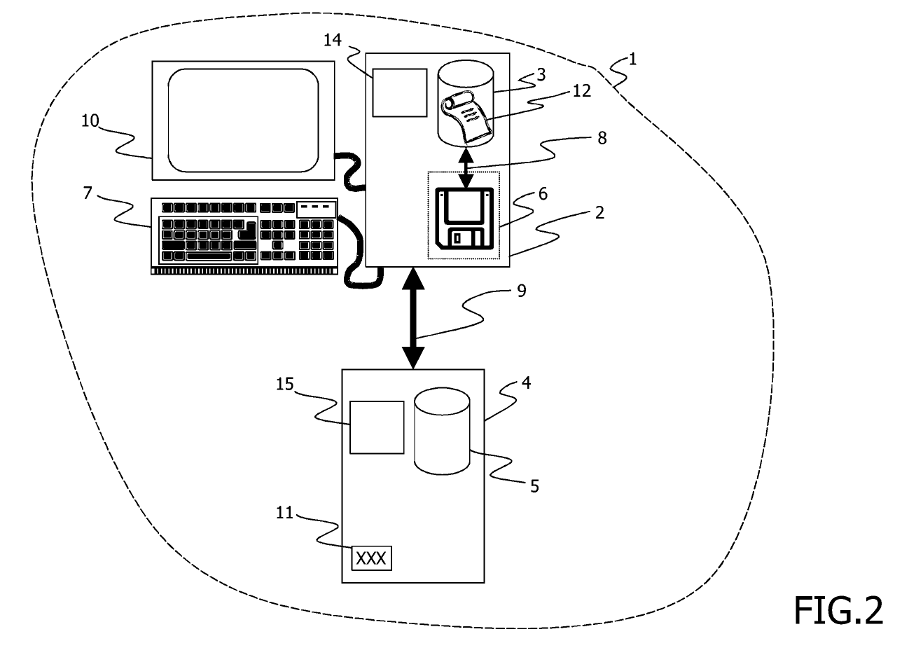

A second embodiment is illustrated in FIG. 2. In this embodiment the first local device 2 comprises the list of information 12, the optional third memory area 6, a storage medium with the first memory area 3, the first processor 14 and the administrative connection 8. The interaction process again makes use of the first processor 14, the display 10 and the user input device 7. Information files are stored in the first memory area 3. The second local device 4 comprises the second processor 15, a storage medium with the second memory area 5, and the unique identification 11. The information file connection 9 allows information files to be exchanged between the first local device 2 and the second local device 4. In the embodiment of FIG. 2 the list of information 12 is again used to denote such administrative information required for the enabling and performing of restore operations. The first processor 14 constructs the list of information 12 by identifying each file transferred to the second memory area 5 from the first memory area 3 using a second plurality of first identifiers. Separation of the list of information 12 and the information files themselves again provides enhanced protection for information files of users from accidental loss. In FIG. 2 the list of information 12 is shown to be stored in the first memory area 3. Further protection can be arranged by storing the list of information 12 in the optional third memory area 6 instead of in the first memory area 5, not shown in FIG. 2. Ideally the optional third memory area 6 would not be accessible to a user in normal operation making accidental deletion of the list of information 12 less likely.

Should accidental deletion of information files occur a user can request the restoration of files using the display 10 and the user input device 7. The first processor 14 then identifies each information file in first memory area 3 using a second plurality of second identifiers. The first processor 14 then compares the second plurality of first identifiers from the list of information 12 with the second plurality of second identifiers. Information files for which one of the second plurality of first identifiers matches one of the second plurality of second identifiers are then restored from first memory area 3 to second memory area 5. In this embodiment the second local device 4 must co-operate with the first local device 2 to perform the activity of restoring files, because the first local device 2 contains unique information required for information file restoration. There is a dependency therefore on the first local device 2 in this embodiment.

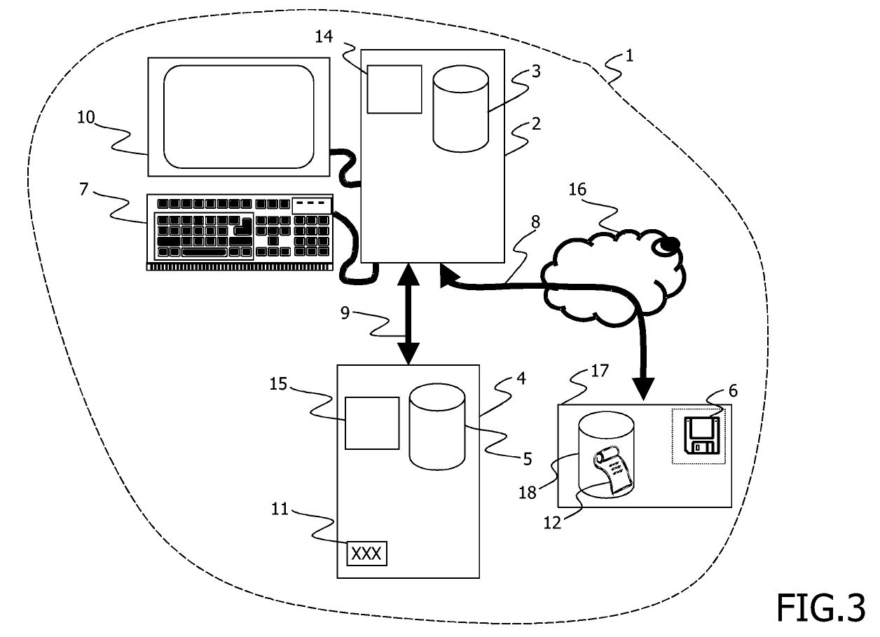

Another embodiment is described with reference to FIG. 3. The embodiment illustrates a system for restoring files in which administration information for restoring files is remotely stored. No information files are remotely stored. A first local device 2 comprising the first processor 14 and the first storage area 3 is connected via the administrative connection 8 to a remote device 17. The administrative connection 8 to the remote device 17 may make use of any intervening network 16 such as, for example, the Internet. A user interacts with the first local device 2 using the display 10 and the user input device 7 to store information files in the first memory area 3 and to select information files to be transferred to the second local device 4. The second local device 4 comprises the second memory area 5, the unique identification 11 and the second processor 15. Information files are transferred to the second memory area 5 of the second local device 4 via information file connection 9. The first processor 14 generates a third plurality of first identifiers to identify each information file of the one or more information files transferred to the second memory area 5. The third plurality of first identifiers are stored in the list of information 12. The list of information 12 may comprise other conditions of storage such as the unique identification 11 of the second local device 4 or optionally time and date information of actions relating to the transfer of information files between the first local device 2 and the second local device 4. In FIG. 3 the list of information 12 is stored in the remote memory area 18 using the administrative connection 8. Optionally, the remote device 17 may also comprise the third memory area 6 for storing the list of information 12 safely.

Files are restored when a user requests restoration via first local device 2. The first processor 14 receives the list of information 12 from the remote memory area 18, or optionally from the third memory area 6, of the remote device 17. The first processor 15 then identifies each information file in first memory area 3 using a third plurality of second identifiers. The first processor 14 then compares the third plurality of first identifiers from the list of information 12 with the third plurality of second identifiers. Information files for which one of the third plurality of first identifiers matches one of the third plurality of second identifiers are then restored from first memory area 3 to second memory area 5. In this embodiment it is advantageous to have the list of information 12 located remotely because the user achieves independence from the first local device 2, which will most likely be a general purpose computer, and he can take the second local device 4 to any other general purpose computer and request restoration. In this embodiment the second local device 4 is required to co-operate with the remote device 17 using the first local device 2 as a proxy to perform the activity of restoring files. This is because the remote device 17 contains unique administrative information required for information file restoration. There is a dependency, therefore, on the remote device 17 in this embodiment. The first local device 2 is only required to execute a program and does not comprise any unique administrative information with respect to the activity of restoring files.

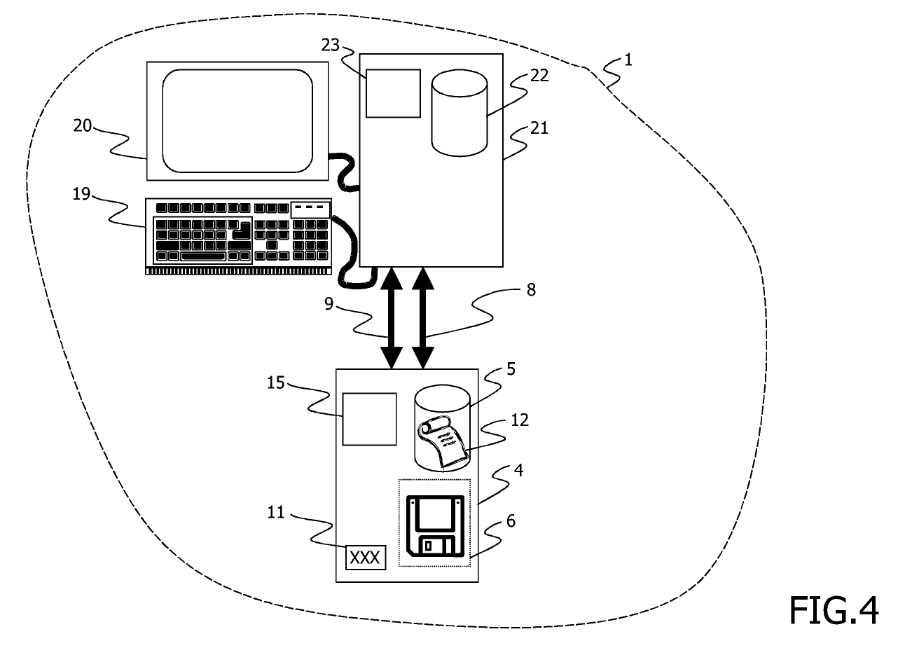

In FIG. 4 an embodiment of a system to restore files for use explicitly in the restoration phase is presented. This is especially advantageous for use in cases where information files are no longer available upon the original source device, for example, the first local device 2, but are nevertheless commonly available. Exemplary forms of such files are audio files, such as MP3 or WMA files since identical files can be found in many repositories, purchased and/or re-encoded from for example the original CD. Further exemplary forms of such information files could be standard executable files, shared library files and so on, i.e. the exe, dll files, available on a general-purpose computer. This embodiment requires that administrative information required for the enabling and performing of restore operations is available. In the embodiment of FIG. 4 use is made of a third local device 21 comprising a second display 20, a second user input device 19, a third processor 23 and a fourth memory area 22. The third local device 21 will be the restoration source of any information files that the system 1 determines can be restored. The third local device 21 does not contain any administrative information required for the enabling and performing of a restore operation. Furthermore, the second local device 4 has a configuration similar to that as shown in FIG. 1 and comprises the second memory area 5, the unique identification 11, the second processor 15 and the optional third memory area 6. The information file connection 9 allows information files to be exchanged between the third local device 21 and the second local device 4. The list of information 12 is again used to denote such administrative information required for the enabling and performing of restore operations. It is required that the third local device can access the location at which the list of information 12 is stored during the restore operation. In FIG. 4 the second local device 4 is shown to comprise the list of information 12, but although not shown in FIG. 4 the list of information 12 could equally be remotely located and be accessible by any standard means. The second local device 4 may optionally comprise a program, executable on a general-purpose information appliance, required for the restore operation. In such a case a user can easily request the restoration of files using the second display 20 and the second user input device 19. The third processor 23 then identifies each information file in the fourth memory area 22 using a plurality of third identifiers. Taking now an example whereby the embodiment of FIG. 1 generated the list of information 12 it should be clear, with reference to the description of FIG. 1, that the list of information 12 comprises a first plurality of first identifiers. The third processor 23 then compares the first plurality of first identifiers from the list of information 12 with the plurality of third identifiers. Information files for which one of the first plurality of first identifiers matches one of the plurality of third identifiers are then restored from fourth memory area 22 to the second memory area 5. In this embodiment the second local device 4 is using the third local device 21 only as a possible source for restoring information files. No unique administrative information for the restoration of information files is contained on the third local device 21 and there is, therefore, no direct dependency upon the third local device 21.

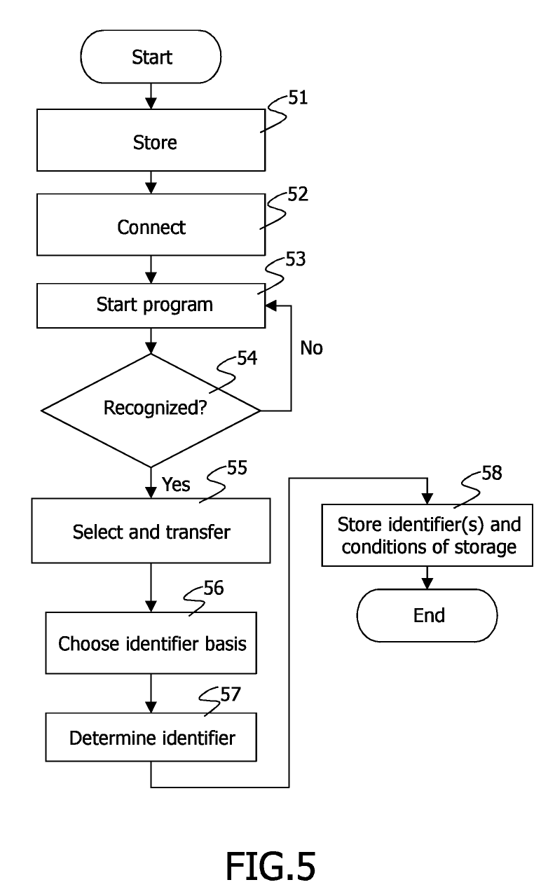

To perform restoration of files it is essential that administrative information is prepared prior to the point at which restoration is required. Referring to FIG. 5 the detailed method of operation of the preparation of the administrative information is described. This preparation phase preferably occurs at a point in time when information files are transferred between devices, with the understanding that the information files may have to be restored at some future point in time. In describing the method of the invention reference is made to essential elements required to perform the method already presented in the embodiments described and shown in FIGS. 1 through 4. An initial step 51 requires a user to store information files on, for example, the first local device 2. An exemplary form for such information files would be an audio MP3 or WMA file. To make use of a mobile storage device, for example, the second local device 4, then the first local device 2 and the second local device 4 must be connected in step 52 by a suitable means. In step 53 a user executes a program for exchanging information files between the first local device 2 and the second local device 4. If the program does not recognize, in step 54, the second local device 4 the user may try again using a more suitable program. In step 55 a suitable program capable of exchanging information files between the first local device 2 and the second local device 4 has been executed and enables a user to select information files, for example audio MP3 or WMA files, and transfer them to the second local device 4. In step 56 a suitable processor, for example the first processor 14 or the second processor 15, identifies which information will be used as an information source upon which an identification of each information file is based. The result of step 56 could be that each information file is identified based upon the metadata related to the information file, such as from a file system. Examples of this form are file size, file name, file creation date and so on. Furthermore, each information file could be identified based upon metadata held within the file, for example, using the common ID3 tag of MP3 audio files. Such metadata contains artist, song title and so on. It is also possible to identify an information file based upon the data contained within the information file using a commonly applied hashing function, such as the MD5, CRC32 or Java hashcode algorithms. Further options of generating a hash function based upon portions of the data contained within the information file are also possible. This is advantageous again in the case of MP3 audio files with ID3 tags, or the equivalent for WMA files. In such cases the encoded audio data most often remains constant and is suitable for identification purposes, but the ID3 metadata can be edited simply and often due to the personal tastes of a specific user and therefore interferes with the ability to identify information files.

In step 57 the suitable processor uses the output from step 56 to perform the identification of the information file. The result is a first identifier substantially smaller in size than the original information file, but essentially capable of uniquely identifying the information file. Storing the first identifier in place of the complete information file spares significant storage space. Step 57 is performed for each information file transferred from the first local device 2 to the second local device 4 resulting in the plurality of first identifiers from the description accompanying FIG. 1. In step 58 the plurality of first identifiers is stored in the list of information 12 along with suitable conditions of storage. The conditions of storage could comprise the time and date at which any information file transfer took place, the unique identification 11 of the second local device 4 and any other suitable information required to restore the complete state of the second local device 4. Upon completion of step 58 all necessary administrative information has been prepared to allow the restoration of information files at a future point in time.

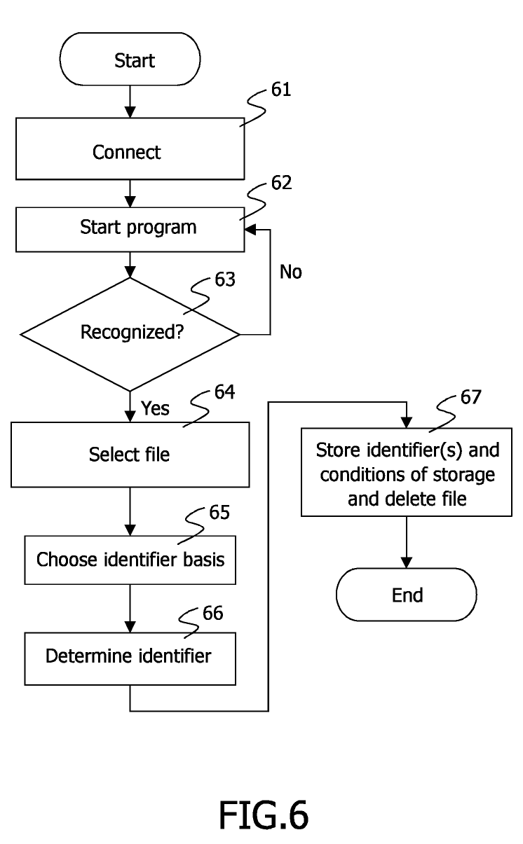

A further common action performed by a user is the deletion of information files from the second local device 4. The method required to delete information files from the second local device 4 is described in the flowchart of FIG. 6. There is some level of commonality with the method of adding files to the second local device 4, as described in the text relating to FIG. 5. Emphasis in the description will be placed on the difference in the required steps. In step 61 the first local device 2 and the second local device 4 are connected. In steps 62 and 63 a user starts a suitable program capable of deleting information files from the second local device 4. In step 64 a user selects the one or more information files to be deleted from the second local device 4. In step 65 the suitable processor identifies which information should be used as an information source upon which an information file to delete identifier is based. In step 66 the information file to delete identifier is determined. This step is performed for each information file to be deleted resulting in a plurality of information file to delete identifiers. In step 67 the list of information 12 is modified to reflect the deletion of the information files to be deleted.

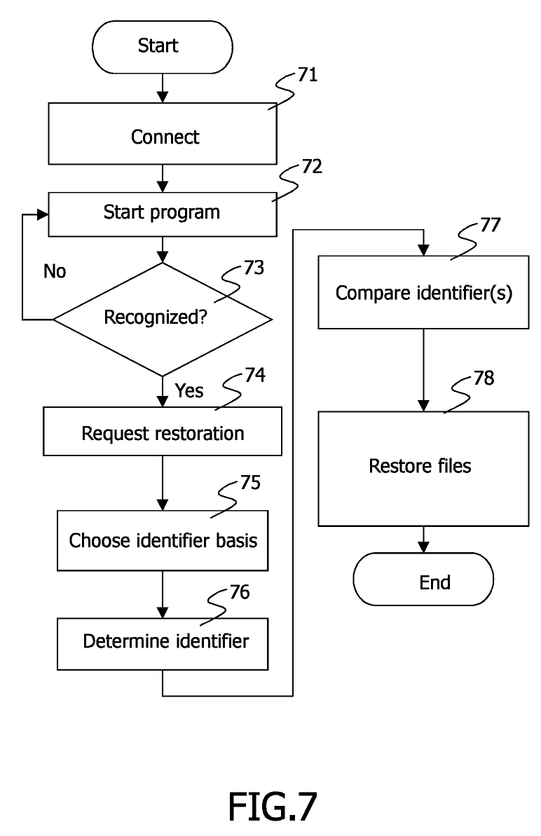

The action of restoring files is crucial to a user who has suffered loss of information files. The method steps taken during the restoration phase are described in the flowchart shown in FIG. 7. Initially in step 71 a user must connect the second local device 4 to a device that can act as a source for restoring the information files to be restored. This may be the first local device 2 from which the information files were originally obtained, but it may also be a third local device 21. It is expected that the chance of successfully restoring the files will vary according to which device is chosen as a source for restoring information files. In steps 72 and 73 a user starts a suitable program capable of restoring information files to the second local device 4. In step 74 the user requests the restoration of information files to the second local device 4.

Assuming first the situation, for steps 75 through 78, when the first local device 2 is used as the source for restoring information files. All information files available in the first memory area 3 of the first local device 2 will be taken into account in defining the information file restoration repository. In step 75 the first processor 14 of the first local device 2 identifies which information from the information files in the information file repository should be used as an information source upon which a second identifier is based. In step 76 the second identifier is determined. This step is performed for each information file in the information file repository resulting in the plurality of second identifiers, first introduced in the description of FIG. 1. In step 77 the list of information 12 is studied and the plurality of first identifiers, first introduced in the description of FIG. 1, of information files to be restored is determined. Each one of the plurality of first identifiers of information files to be restored is compared to each one of the plurality of second identifiers determined in step 76. In step 78 information files for which the comparison of step 77 is true can be, and are, restored from the first memory area 3 of the first local device 2 to the second memory area 5 of the second local device 4.

Optionally, assuming secondly the situation, for steps 75 through 78, when the third local device 21 is used as the source for restoring information files. All information files available in the fourth memory area 22 of the third local device 21 may be taken into account in defining the information file restoration repository. In step 75 the third processor 23 of the third local device 21 identifies which information from the information files in the information file repository should be used as an information source upon which a third identifier is based. In step 76 the third identifier is determined. This step is performed for each information file in the information file repository resulting in a plurality of third identifiers. In step 77 the list of information 12 is studied and a plurality of first identifiers of information files to be restored is determined. Each one of the plurality of first identifiers of information files to be restored is compared to each one of the plurality of third identifiers determined in step 76. In step 78 information files for which the comparison of step 77 is true can be, and are, restored from the fourth memory area 22 of the third local device 21 to the second memory area 5 of the second local device 4.

It should be evident that the invention as described and elucidated upon by the description and embodiments presented demonstrates that individual steps of the method of the present invention may be performed at multiple localities within the system claimed. Whilst the described embodiments attempt to show this flexibility in the locality of the method steps it should also be apparent to a person skilled in the art that other suitable combinations are also possible. It should also be noted that the above-mentioned embodiments in general illustrate rather than limit the invention, and that those skilled in the art will be able to design many alternative embodiments without departing from the scope of the appended claims. Use of the verb “comprise” and “include” and its conjugations do not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. A program product may be stored and/or distributed on a suitable medium, such as an optical storage medium, but may also be distributed in other forms, such as being distributed via the Internet or wired or wireless telecommunications systems. In a system/device/apparatus claim enumerating several means, several of these means may be embodied by one and the same item of hardware. The mere fact that certain measures are recited in mutually different dependant claims does not indicate that a combination of these measures cannot be used to advantage. Finally, reference signs within the claims are presented for the sole purpose of describing the invention and are in no way meant to limit the scope of the claims.

1-16. (canceled)

17. A method for restoring files, the method comprising:
storing (51) a plurality of files in a first memory area (3);
selecting (7, 10, 55) a selection of files comprising of at least one of said plurality of files;
storing (9, 55) of said selection of files in a second memory area (5);
identifying (57) with a plurality of first identifiers each file of said selection of files;
storing (8, 58) said first identifiers and conditions of storage in a list of information (12), wherein said list of information (12) being distinguished from said files;
receiving (7, 10, 19, 20, 74) a request from a user for a file to be restored to said second memory area (5); characterized in
identifying (76) with a plurality of second identifiers each file of said plurality of files stored in said first memory area (3);
comparison (77) of equality of each one of said first identifiers corresponding to said file to be restored with each one of said second identifiers; and
restoring (78) said file to be restored to said second memory area (5) from said first memory area (3) for which said comparison is true.

18. The method of claim 17 further comprising:
determination (57) of said first identifiers, during said identifying with a plurality of first identifiers, using a hashed function of the data related to or contained within each file of the said selection of files.

19. The method of claim 17 further comprising:
determination (57) of said first identifies, during said identifying with a plurality of first identifiers, wherein said data comprises of metadata extracted from or related to each file of the said selection of files.

20. The method of claim 19 further comprising:
determination (57) of said first identifiers, during said identifying with a plurality of first identifiers, wherein said metadata comprises metadata contained within audio files.

21. The method of claim 17 further comprising:
storing said list of information (12) in one of a selection from:
said first memory area (3);
said second memory area (5);
a third memory area not accessible to a user (6);
a remote memory area (18).

22. The method of claim 17 further comprising:
identifying (76) with a plurality of third identifiers each file of a plurality of files stored in a fourth memory area (22);
comparison (77) of equality of each one of said first identifiers of said files to be restored with each one of said third identifiers; and
restoring (78) said files to be restored to said second memory area (5) for which said comparison is true.

23. The method of claim 17 further comprising:
identifying the time (13, 58) at which the storage of said selection of files occurred;
performing unique identification (11, 58) of said second memory area (5); and
storing (58) said time (13) and said unique identification (11) as said conditions of storage.

24. The method of claim 17 further comprising:
identifying (74) a point of time (13) for restoration from said request; and
restoring (78) said second memory area (5) to a point in time equating to said point of time (13) for restoration of said request.

25. An information processing system for restoring files, the system comprising:
means for storing (51) a plurality of files in a first memory area (3);
means for selecting (7, 10, 55) a selection of files comprising of at least one of said plurality of files;
means for storing (9, 55) of said selection of files in a second memory area (5);
means for identifying (57) with a plurality of first identifiers each file of said selection of files;
means for storing (8, 58) said first identifiers and conditions of storage in a list of information (12);
means for receiving (7, 10, 19, 20, 74) a request from a user for files to be restored to said second memory area (5); characterized in
means for identifying (76) with a plurality of second identifiers each file of said plurality of files stored in said first memory area (3);
means for performing a comparison (77) of equality of each one of said first identifiers of said files to be restored with each one of said second identifiers; and
means for restoring (78) said files to be restored to said second memory area (5) for which said comparison is true.

26. The system of claim 25 further comprising:
a first local device (2);
said first local device (2) containing a first storage medium;
said first storage medium further containing said first memory area (3);
a second local device (4);
said second local device (4) containing a second storage medium; and
said second storage medium further containing said second memory area (5).

27. The system of claim 25 further comprising:
means for storing said list of information (12) in one of a selection from:
said first memory area (3);
said second memory area (5);
a third memory area not accessible to the user (6); and
a remote memory area (18).

28. The system of claim 27 further comprising:
a third storage medium containing said third memory area (6) not accessible to the user.

29. The system of claim 25 further comprising:
a third local device (21);
said third local device (21) containing a fourth storage medium;
said fourth storage medium further containing a fourth memory area (22);
means for identifying (76) with a plurality of third identifiers each file of a plurality of files stored in said fourth memory area (22);
means for performing comparison (77) of equality of each one of said first identifiers of said files to be restored with each one of said third identifiers; and
means for restoring (78) said files to be restored to said second memory area (5) for which said comparison is true.

30. A computer-readable recording medium containing a program for controlling an information processing apparatus for restoring files, said program enabling said information processing apparatus to perform the method steps of:
storing (51) a plurality of files in a first memory area (3);
selecting (7, 10, 55) a selection of files comprising of at least one of said plurality of files;
storing (9, 55) of said selection of files in a second memory area (5);
identifying (57) with a plurality of first identifiers each file of said selection of files;
storing (8, 58) said first identifiers and conditions of storage in a list of information (12);
receiving (7, 10, 19, 20, 74) a request from a user for files to be restored to said second memory area (5); characterized in
identifying (76) with a plurality of second identifiers each file of said plurality of files stored in said first memory area (3);
comparing (77) equality of each one of said first identifiers of said files to be restored with each one of said second identifiers; and
restoring (78) said files to be restored to said second memory area (5) for which said comparison is true.

31. A program for controlling an information processing apparatus for restoring files, said program enabling said information processing apparatus to perform the method steps of:
storing (51) a plurality of files in a first memory area (3);
selecting (7, 10, 55) a selection of files comprising of at least one of said plurality of files;
storing (9, 55) of said selection of files in a second memory area (5);
identifying (57) with a plurality of first identifiers each file of said selection of files;
storing (8, 58) said first identifiers and conditions of storage in a list of information (12);
receiving (7, 10, 19, 20, 74) a request from a user for files to be restored to said second memory area (5); characterized in
identifying (76) with a plurality of second identifiers each file of said plurality of files stored in said first memory area (3);
comparing (77) equality of each one of said first identifiers of said files to be restored with each one of said second identifiers; and
restoring (78) said files to be restored to said second memory area (5) for which said comparison is true.
